(19) United States
(12) Patent Application Publication
(10) Pub. No.: US 2004/0062465 A1
(43) Pub. Date: Apr. 1, 2004

(54) Apparatus and method for measuring optical power as a function of wavelength

(76) Inventors: Bruce Robert Woodley, Mountain View, CA (US); Neil MacKinnon, San Jose, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/260,350

(22) Filed: Oct. 1, 2002

(51) Int. Cl. G02F 1/035; G02B 6/26

(52) U.S. Cl. 385/2; 385/15; 385/40

(57) ABSTRACT

A system and method are disclosed for measuring optical power as a function of wavelength. Exemplary embodiments of the present invention comprise a waveguide structure having at least one waveguide. The at least one waveguide is comprised of an electro-optic material. The at least one waveguide includes an input end for receiving a beam of optical energy and an output end. A plurality of electrodes are disposed in close proximity along a longitudinal axis of the at least one waveguide. The voltages on a sub-plurality of the plurality of electrodes are independently controlled to alter the index of refraction of the at least one waveguide at positions adjacent to each sub-plurality of electrodes to pass a selected portion of the beam of optical energy. The output end passes the selected portion of the beam of optical energy to, for example, an apparatus that measures incident optical energy.

### CROSS REFERENCE TO RELATED APPLICATIONS

This application is related to U.S. patent application entitled “Wavelength Agile Laser,” Ser. No. 09/954,495, filed Sep. 10, 2001, and to U.S. patent application entitled “Wavelength Agile Laser,” Ser. No. ______ filed Sep. 17, 2001 (which is a continuation-in-part of U.S. patent application Ser. No. 09/954,495), each of which is incorporated herein by reference in their entirety.

### BACKGROUND

1. Field of the Invention

The present invention relates to optical networks employing dense wavelength division multiplexing. More particularly, the present invention relates to a system and method for measuring the optical power in a fiber as a function of wavelength.

2. Background Information

Dense wavelength division multiplexing (DWDM) technology is used to transport large volumes of information over a single fiber. DWDM enables the transmission of multiple “colors” or wavelengths of light over a single fiber, thereby greatly enhancing data throughput. The source for each wavelength of light is a single frequency laser that is tuned to a precise wavelength during manufacture and/or during operation. Transmission lasers can be designed to operate with a single wavelength for the duration of their useful life, or can be designed to be “tunable”, that is, their wavelength of operation can be changed if desired.

DWDM systems typically comprise multiple, separately-modulated laser systems at the transmitter. These laser systems are designed or actively tuned to operate at different wavelengths.

When their emissions are combined in an optical fiber, the resulting DWDM optical signal has a corresponding number of spectrally separated channels. Along the transmission link, the channels can be collectively amplified in semiconductor amplifier systems or gain fiber, such as erbium-doped fiber and/or regular fiber, although semiconductor optical amplifiers are also used in some situations.

At the receiving end, the channels can be separated from each other using, for example, thin film filter systems to thereby enable detection by separate detectors, such as photodiodes.

For telecommunications applications involving DWDM, the wavelength range used is in what is known as the “third window.” The third window is the spectral region within which the attenuation exhibited by the transmission medium (commonly silica glass) is the lowest. Although loosely defined, the third window can be identified to lie in the spectral region from approximately 1500 nanometers (nm) to approximately 1650 nm. Within this window the designations “S”, “C” and “L” represent subdivisions (i.e., bands) of this spectral region. An object of optical power monitor performance is, therefore, the capability to address the spectral region associated with S, C and L-band wavelengths. A further object of an optical power monitor is that it can reference energy readings to what is known as the “ITU grid.” The ITU grid is a defined standard covering the placement, in frequency space, of optical channels launched onto a fiber.

The structure that optical performance requirements set on fiber optic networks is described in, for example, J. Gowar, “Optical Communications Systems”, Second Edition, Prentice Hall International Series in “Optoelectronics,” pages 257 to 487, inclusive.

The advantage of DWDM systems is that the transmission capacity of a single fiber can be increased. Historically, only a single channel was transmitted in each optical fiber. In contrast, modem DWDM systems contemplate hundreds of spectrally separated channels per fiber. This yields concomitant increases in the data rate capabilities of each fiber. Moreover, the cost per bit of data in DWDM systems is typically less than comparative non-multiplexed systems. This is because optical amplification systems required along the link are shared by all of the separate wavelength channels transmitted in the fiber. With non-multiplexed systems, each channel/fiber would require its own amplification system.

However, there are challenges associated with implementing DWDM systems. First, the transmitters and receivers are substantially more complex since, in addition to the laser diodes and receivers, optical components are required to combine the channels into, and separate the channels from, the DWDM optical signal. Moreover, there is the danger of channel drift where the channels lose their spectral separation and overlap each other. This interferes with channel separation and demodulation at the receiving end.

Thus, it is important that the operator of a DWDM system be able to monitor the energy in a fiber as a function of wavelength at many points throughout a fiber optic communications network. Not only does this enable the detection of wavelength drift, but monitoring of the optical energy that is contained in the wavelengths can be used to diagnose other problems, such as reduction of laser transmission power, changes in the transmission losses of optical components and fiber, and increases in noise in optical amplifier stages.

One method of measuring the optical power in a fiber as a function of wavelength is to separate the light spatially as a function of wavelength, using a device such as a grating. The spatially separated light can then strike an array of photodetectors, thereby measuring the power in the light as a function of wavelength. The precision of alignment of such a configuration, and the need for a large number of calibrated photodetectors potentially renders such a system costly. In addition, the passive optics for spatially separating the light as a function of wavelength become very exacting as the desired wavelength resolution becomes small.

Another method of measuring the optical power as a function of wavelength uses a single photodetector that can be mechanically translated across the separated light, thereby measuring power as a function of wavelength. Similarly, the diode can remain stationary, and the grating can be rotated and/or translated. Similarly, the grating and diode can remain stationary, and a mirror or lens between the two can be rotated and/or translated. In each of these implementations, the speed of scanning is limited by mechanical issues, such as structural resonance and alignment tolerances. In addition, lifetime issues due to wear and thermal issues must be carefully addressed.

### SUMMARY OF THE INVENTION

A system and method are disclosed for measuring optical power as a function of wavelength. The present invention can produce a stable optical power monitor that can report optical power as a function of wavelength. In accordance with exemplary embodiments of the present invention, a rapidly-tunable, narrow-band, polarization-insensitive filter can rapidly sweep through the wavelength band of interest. The output of this wavelength selective filter is then directed at a device that can detect optical power, such as a photodiode. Accordingly, the power present in the fiber at a given wavelength can be measured. The rapidly-tunable filter can be readjusted to take another measurement at a different wavelength, and, consequently, the optical power can be measured as a function of wavelength.

According to one aspect of the present invention, an apparatus for measuring optical power as a function of wavelength comprises a waveguide structure. The waveguide structure includes at least one waveguide. Each of the at least one waveguide is comprised of an electro-optical material. Each of the at least one waveguide includes an input end and an output end, wherein the input end is configured to receive a beam of optical energy, and wherein the output end is configured to pass the beam of optical energy. The apparatus includes a plurality of electrodes disposed in close proximity to at least one waveguide of the waveguide structure and disposed along a longitudinal axis of the at least one waveguide. The apparatus also includes circuitry that independently controls voltages on a sub-plurality of electrodes of the plurality of electrodes to alter an index of refraction of the at least one waveguide at positions adjacent to each sub-plurality of electrodes to pass a selected portion of the beam of optical energy. The apparatus includes means for measuring the optical power of the selected portion of the beam of optical energy. The output end passes the selected portions of the beam of optical energy to, for example, an apparatus that measures incident optical energy or any other device. The energy measurement can then be made available to an external apparatus, such as a digital computer or other circuitry or devices.

According to exemplary embodiments of the present invention, a polarization splitter can separate the beam of optical energy into its separate polarization components, each of which propagates along its own waveguide(s) within the electro-optic material. Polarizers can be provided near the output of each guided mode of energy, or can be provided at one or more points along each guided mode of energy. A structure that simultaneously selects one polarization from each waveguide and combines this energy into a single waveguide can be used prior to the light exiting the electro-optic material, or at other intermediate stages in the device, thereby acting as both a polarizer and a waveguide combiner.

According to another exemplary embodiment of the present invention, the waveguide structure can be constructed such that the light travels the length of the device more than once before being output. If the light travels the length of the device more than once, it can travel through a different waveguide or waveguides each time it travels the length of the device. If the light travels through a different waveguide or waveguides each time it travels the length of the device, a waveguide structure that simultaneously couples light from one waveguide to another while reversing the direction of propagation can be used. Alternatively, a waveguide structure can be used that simultaneously couples light from the transverse electric (TE) polarization mode in the first waveguide to the transverse magnetic (TM) polarization mode in the second waveguide, couples light from the TM polarization mode in the first waveguide to the TE polarization mode in the second waveguide, and can reverse the direction of propagation.

According to second aspect of the present invention, an apparatus for measuring optical power as a function of wavelength comprises a body comprised of at least one sub-body. Each of the at least one sub-body comprises an electro-optical material. Each of the at least one sub-body includes an input end for receiving an energy beam from an energy beam source, an output end for emitting an output energy beam, and a longitudinal axis. The apparatus also includes a plurality of electromagnetic fields in close proximity to the at least one sub-body and disposed along a longitudinal axis of the at least one sub-body. The apparatus includes circuitry that alters an index of refraction of the at least one sub-body along the longitudinal axis by altering a sub-plurality of the plurality of electromagnetic fields to emit a selected portion of the energy beam. The apparatus also includes means for measuring the optical power of the selected portion of the energy beam.

According to a third aspect of the present invention, a method for measuring optical power comprises the steps of: i.) placing a waveguide structure in optical communication with a beam of optical energy, wherein the waveguide structure includes at least one waveguide, each of the at least one waveguide being comprised of an electro-optical material, wherein each of the at least one waveguide includes an input end and an output end, wherein the input end is configured to receive the beam of optical energy, wherein the output end is configured to pass the beam of optical energy; ii.) disposing a plurality of electrodes in close proximity to at least one waveguide of the waveguide structure and along a longitudinal axis of the at least one waveguide; iii.) altering an index of refraction of the at least one waveguide at positions adjacent to each of a sub-plurality of electrodes of the plurality of electrodes by independently controlling voltages on a sub-plurality of electrodes to pass a selected portion of the beam of optical energy; and, iv.) measuring the optical power of the selected portion of the beam of optical energy.

According to a fourth aspect of the present invention, a method for measuring optical power comprises the steps of: i.) placing a body in optical communication with an energy beam, wherein the body includes at least one sub-body, wherein each of the at least one sub-body comprises an electro-optical material, each sub-body including an input end for receiving the energy beam, an output end for emitting an output energy beam, and a longitudinal axis; ii.) disposing a plurality of electromagnetic fields in close proximity to the at least one sub-body and along a longitudinal axis of the at least one sub-body; iii.) altering an index of refraction of the at least one sub-body along the longitudinal axis by altering a sub-plurality of the plurality of electromagnetic fields to emit a selected portion of the energy beam; and, iv.) measuring the optical power of the selected portion of the energy beam.

Accordingly, exemplary embodiments of the present invention can independently control individual electrodes, groups of electrodes, or subgroups of electrodes within the groups of electrodes to effect wavelength dependent polarization mode conversion in a polarization insensitive device to produce a polarization independent filter. In addition, exemplary embodiments can provide a multistage filter by forcing the light to transit the length of the device more than once. Furthermore, exemplary embodiments can provide a general-purpose tunable optical filter that has low polarization mode dispersion (PMD) and low polarization dependent loss (PDL) by forcing the optical signal to transit the device an even number of times, wherein the polarization of the energy in the optical signal is reoriented at each change in propagation direction.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a side view of a system for measuring optical power, in accordance with an exemplary embodiment of the present invention.

FIG. 2 is a block diagram illustrating a top view of a system for measuring optical power, in accordance with an exemplary embodiment of the present invention.

FIG. 3 is a block diagram illustrating a top view of a system for measuring optical power, in accordance with an exemplary embodiment of the present invention.

FIG. 4 is a block diagram illustrating a top view of a system for measuring optical power, in accordance with an exemplary embodiment of the present invention.

FIG. 5 is a block diagram of a system for measuring optical power, in accordance with an exemplary embodiment of the present invention.

FIG. 6 is a flowchart illustrating steps for measuring optical power, in accordance with an exemplary embodiment of the present invention.

FIG. 7 is a flowchart illustrating steps for separating a beam of optical energy into polarization components, in accordance with an exemplary embodiment of the present invention.

FIG. 8 is a flowchart illustrating steps for altering an index of refraction of at least one waveguide, in accordance with an exemplary embodiment of the present invention.

FIG. 9 is a flowchart illustrating steps for measuring optical power, in accordance with an alternative exemplary embodiment of the present invention.

FIG. 10 is a flowchart illustrating steps for altering an index of refraction of at least one sub-body, in accordance with an exemplary embodiment of the present invention.

FIG. 11 is a flowchart illustrating steps for independently controlling voltages on a sub-plurality of a plurality of electrodes, in accordance with an exemplary embodiment of the present invention.

### DETAILED DESCRIPTION OF THE PREFERRED EMBODIMENTS

Exemplary embodiments of the present invention are directed to a method and apparatus for measuring optical power. The present invention can produce a stable optical power monitor that can report optical power as a function of wavelength. In accordance with exemplary embodiments of the present invention, a rapidly-tunable, narrow-band, polarization-insensitive filter can rapidly sweep through the wavelength band of interest. The output of this wavelength-selective filter can be directed at a device that can detect optical power, such as a photodiode. Accordingly, the power present in the fiber at a given wavelength can be measured. The rapidly-tunable filter can be readjusted to take another measurement at a different wavelength, and, consequently, the optical power can be measured as a function of wavelength.

According to an exemplary embodiment, an apparatus for measuring the optical power comprises a waveguide structure. The waveguide structure includes at least one waveguide. Each of the waveguides includes an input end and an output end. Each of the waveguides is comprised of an electro-optic material, in which the input end receives a beam of optical energy from the source that is to be measured. A plurality of electrodes are disposed in close proximity along a longitudinal axis of each of the waveguides. Circuitry independently controls voltages on a sub-plurality of the plurality of electrodes to alter the index of refraction of each of the waveguides at positions adjacent to each sub-plurality of electrodes to pass a selected portion of the beam of optical energy. According to exemplary embodiments, the sub-plurality of electrodes can be individual electrodes, a group of electrodes, or a subset of a group of electrodes. There can be a sub-plurality of electrodes in proximity to each waveguide in the waveguide structure, or a sub-plurality of electrodes can be in proximity to more than one waveguide within the waveguide structure. The output end passes the selected portions of the beam of optical energy to, for example, an apparatus that measures incident optical energy or any other device. The energy measurement can then be made available to external apparatus, such as a digital computer or other circuitry or devices.

Exemplary embodiments can include a polarization splitter that can separate the beam of optical energy into its separate polarization components, each of which propagates along its own waveguide(s) within the electro-optic material. Polarizers can be provided near the output of each guided mode of energy, or can be provided at one or more points along each guided mode of energy. A structure that simultaneously selects one polarization from each waveguide and combines this energy into a single waveguide can be used prior to the light exiting the electro-optic material, or at other intermediate stages in the device, thereby acting as both a polarizer and a waveguide combiner.

According to an alternative exemplary embodiment, the waveguide structure can be constructed such that the light travels the length of the device more than once before being output. If the light travels the length of the device more than once, it can travel through a different waveguide or waveguides each time it travels the length of the device. If the light travels through a different waveguide or waveguides each time it travels the length of the device, a waveguide structure that simultaneously couples light from one waveguide to another while reversing the direction of propagation can be used. Alternatively, a waveguide structure can be used that simultaneously couples light from the transverse electric (TE) polarization mode in the first waveguide to the transverse magnetic (TM) polarization mode in the second waveguide, couples light from the TM polarization mode in the first waveguide to the TE polarization mode in the second waveguide, and reverses the direction of propagation.

Accordingly, exemplary embodiments of the present invention can independently control individual electrodes, groups of electrodes, or subgroups of electrodes within the groups of electrodes to effect wavelength dependent polarization mode conversion in a polarization insensitive device to produce a polarization independent filter. In addition, exemplary embodiments can provide a multistage filter by forcing the light to transit the length of the device more than once. Furthermore, exemplary embodiments can provide a general-purpose, tunable, optical filter that has low polarization mode dispersion (PMD) and low polarization dependent loss (PDL) by forcing the beam of optical energy to transit the device an even number of times, wherein the polarization of the energy in the beam of optical energy is reoriented at each change in propagation direction.

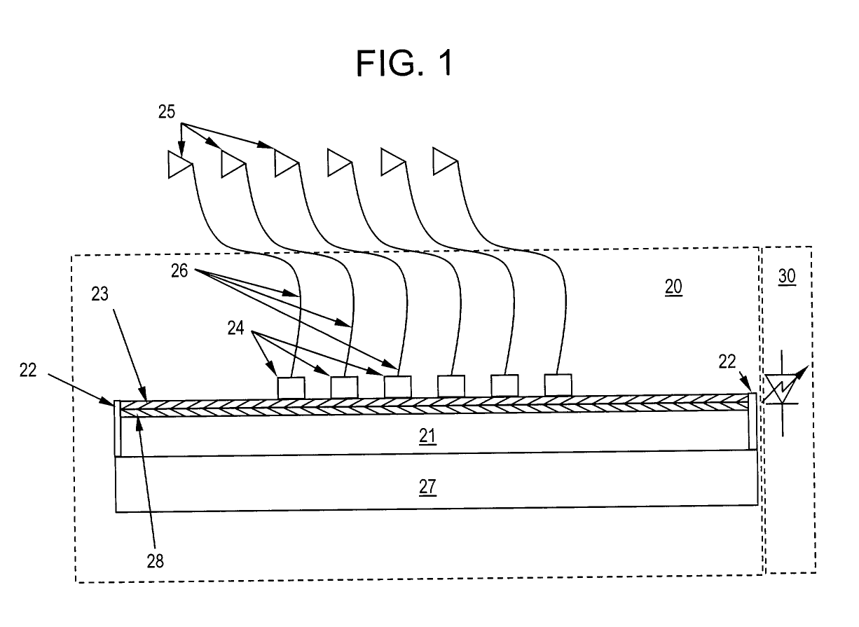

These and other aspects of the present invention will now be described in greater detail. Referring to FIG. 1, an optical performance monitor according to exemplary embodiments of the present invention comprises a tunable optical filter 20 and a photodetector 30. Devices with sufficient resolution and functionality to perform signal-to-noise ratio (SNR) measurements are referred to as “optical performance monitors.” The optical filter 20 acts to select a portion of the incoming light power, whereas the photodetector 30 measures the amount of power that is in the light that has been selected.

According to an exemplary embodiment, an electro-optic chip 21 is x-cut, y-propagating lithium niobate (LiNbO₃). However, other similar electro-optic materials can be used. For example, the electro-optic chip 21 can be y-cut, x-propagating lithium niobate. Alternatively, the electro-optic chip 21 can be z-cut, x-propagating lithium niobate or z-cut, y-propagating lithium niobate. In this orientation, the waveguide in LiNbO₃ is birefringent; that is, the effective indices of the TM mode and the TE mode can be significantly different. Thus, the propagation constants for these modes can also be significantly different.

Waveguides 28 can be constructed in lithium niobate via the titanium indiffusion process. However, the waveguides 28 can be constructed using any method for constructing waveguides in an electro-optic material. In an exemplary embodiment, the waveguides can be formed by depositing an approximately 1100 angstroms (A) thick layer of titanium, and patterning each waveguide to a nominal width of 7 micrometers (um). However, different thicknesses and widths can be used. Standard liftoff lithographic techniques can be used. The wafer can then be placed in a diffusion oven, where the wafers can be heated at 5 degrees Celsius (C) per minute to 1025 degrees C, held for approximately 8.5 hours, then cooled at 2 degrees C per minute to room temperature. However, the rate of heating, the maximum temperature, the time during which the wafer is heated at the maximum temperature, and the rate of cooling can vary depending on the type and amount of materials used, the lithographic techniques used, and the like. During this process, whenever the wafers are hotter than 100 degrees C, 1.5 liters/minute or an otherwise appropriate amount of wet gaseous oxygen can be flowed through the diffusion oven. The oxygen can be approximately 85% relative humidity at room temperature. The humidity can be achieved by bubbling the oxygen through a column of de-ionized water approximately 15 cm high, or by using other appropriate techniques.

According to exemplary embodiments, the electro-optic chip 21 comprises x-cut lithium niobate approximately 1 millimeter (mm) thick, approximately 76 mm long, and approximately 1.4 mm wide, although other dimensions and materials can be used. The waveguide can have an anti-reflective dielectric stack surface 22 disposed on its input and output faces (where the reflectivity is less than, for example, 10⁻³), as shown in FIG. 1. The facets of the input and output surfaces can be angled at approximately 5 degrees in order to further reduce their reflectivity. A buffer layer 23 can be overlaid upon the upper surface of the electro-optic chip 21. The buffer layer 23 can comprise an optically non-absorbing material such as, for example, silica (SiO₂), Y₂O₃, Si₃N₄, or the like. The buffer layer 23 can cover the entire length upon which a plurality of electrodes 24 are to be overlaid. The buffer layer 23 can be approximately 5000 A thick, or any desired thickness.

Electrodes 24 can be electrically coupled to a voltage source 25, such as an array of voltage sources V1, V2, . . . Vn, by connection means 26. The electrodes 24 can be electrically coupled to the voltage source 25 in a variety of configurations. According to an exemplary embodiment, each of the electrodes 24 can be electrically coupled to the voltage source 25. According to this exemplary embodiment, the voltage levels applied to the electrodes 24 are controlled independently of one another to create a widely-tunable optical filter. The optical filter can be constructed in an electro-optic material such that nearly arbitrary optical transfer functions can be synthesized. According to this exemplary embodiment, the independently-controlled electrodes 24 can be used to synthesize an optical filter with the desired optical transfer function. In this manner, it is possible to synthesize optical filters at frequencies from, but not including, DC, up to and including the spatial Nyquist rate for the optical filter.

As described, for example, in U.S. patent application Ser. No. 09/954,495, the voltage levels V1-Vn can be determined from a mathematical model of a to-be-synthesized electric field that can be selected by a designer of a device in which the electric field is used. The designer can select a mathematical model of the electric field, based on a number of factors, such as the physical principles involved in using the electric field. Examples include coupling between (a) two forward propagation modes of light and (b) a forward propagation mode and a backward propagation mode. In one exemplary embodiment, each voltage level VI can determined (based on a preselected mathematical model of the to-be-generated electric field) to be any value in a predetermined range, e.g., 0-20 volts, or any other voltage range. However, the independently-controlled voltage levels V1-Vn can be chosen in any manner to have any voltage levels to synthesize an optical filter with a desired optical transfer function.

In many optical applications, however, it is not necessary to control the optical transfer function at optical frequencies below a certain limit, hereinafter referred to as fₘᵢₙ. Exploiting this freedom, it is possible to choose the voltages on the electrodes 24 such that the voltage on each electrode is identical to the voltage applied to several other nearby electrodes, thereby forming groups of electrodes.

According to an alternative exemplary embodiment of the present invention, the electrodes can be organized into groups of electrodes. The electrodes within each group can also be organized into a plurality of subgroups of electrodes. According to an exemplary embodiment, each group of electrodes can comprise two subgroups of electrodes, and each subgroup of electrodes comprises five electrodes, although each group can comprise any number of subgroups and each subgroup can comprise any number of electrodes. The electrodes in a subgroup can be electrically-connected to each other, while each group of electrodes can be electrically-insulated from all other groups of electrodes. The voltage levels can then be applied not only independently to each group of electrodes, but also independently to each subgroup of electrodes within each group of electrodes.

According to these alternative exemplary embodiments, the electrodes 24 can be organized into groups of electrodes, wherein each group of electrodes comprises at least two electrodes 24. Each group of electrodes would then be electrically coupled to the voltage source 25. According to another alternative exemplary embodiment, the electrodes 24 within each group of electrodes can be organized into a plurality of subgroups of electrodes. Each subgroup of electrodes within each group of electrodes would then be electrically coupled to the voltage source 25.

Thus, according to this alternative exemplary embodiments, by independently controlling groups of electrodes and subgroups of electrodes within the groups of electrodes, an optical filter with the desired optical transfer function can be synthesized to control the frequency response over a fraction of the total frequency band. In this manner, it is possible to synthesize optical filters at frequencies from (1-1/L)f_{nyquist} up to the Nyquist rate for the optical filter. For example, for L=10 electrodes (i.e., each group of electrodes comprises ten electrodes), it is possible to control the frequency response from (1-1/L)f_{nyquist}=(1-1/10)f_{nyquist}=0.90f_{nyquist}=90% of the Nyquist rate for the optical filter to the Nyquist rate of the optical filter. The transfer function of the desired fraction of the total of the frequency band will then be replicated in the other frequency bands (e.g., for L=10, the first tenth of the frequency band, the second tenth of the frequency band, and so forth). However, any number of electrodes can be grouped together to synthesize a transfer function to control the frequency response of any desired fraction of the frequency band.

The voltage sources can each be a digital to analog converter (DAC), or can consist of analog sample-and-hold circuits that time share a single DAC, or can be a switch array that connects the electrodes to just one of many fixed voltage references. Fewer voltage sources can be used if the electrode voltages can be chosen such that a number of electrodes that are physically near each other can have identical voltages applied, for example, as either groups of electrodes or subgroups of electrodes within each group of electrodes. Accordingly, permanent connections can be established between these electrodes on the electro-optic substrate, and one or more voltage sources can be used to drive this plurality of electrodes 24.

For example, 5121 electrodes can be used, with electrodes on an approximately 10.5 um pitch, where each electrode is approximately 5.5 um wide with approximately 5 um of space between each electrode. However, any number of electrodes can be used, at any pitch, of any dimension, and with any desired spacing between the electrodes, depending on the desired control of the transfer function of the optical filter. The electrodes 24 can be deposited using standard photolithographic liftoff techniques. The electrodes 24 can be formed using, for example, an approximately 200 A thick Cr adhesion layer and, for example, an approximately 5000 A thick Au layer. For purposes of illustration and not limitation, electrodes 1, 3, 5, . . . , 5121 can be connected to a reference ground, while electrodes 2, 4, 6, 8, 10 can be connected to V1, electrodes 12, 14, 16, 18, 20 can be connected to V2, and so on. Thus, for example, each group of electrodes can comprise two subgroups of electrodes (e.g., a first group comprising electrodes 1, 3, 5, 7, and 9 connected to a reference ground, and a second group of electrodes comprising electrodes 2, 4, 6, 8, and 10 connected to V1), and each subgroup of electrodes comprises five electrodes. However, the electrodes can be individually electrically-coupled to the respective voltage sources, or, alternatively, each group of electrodes can comprise any number of subgroups and each subgroup can comprise any number of electrodes, with each group or subgroup of electrodes electrically-connected to a respective voltage source.

The electro-optic waveguide 21 can be affixed to a submount 27. The submount 27 can comprise oxygen-free copper, or any other similar material, that is large enough to simplify material handling during assembly and that has been plated with nickel, gold or any other similar material that can prevent corrosion. The output beam from the electro-optic waveguide 21 can be transmitted to a photodetector 30, which can be a photodiode or any other device for detecting a beam of optical energy.

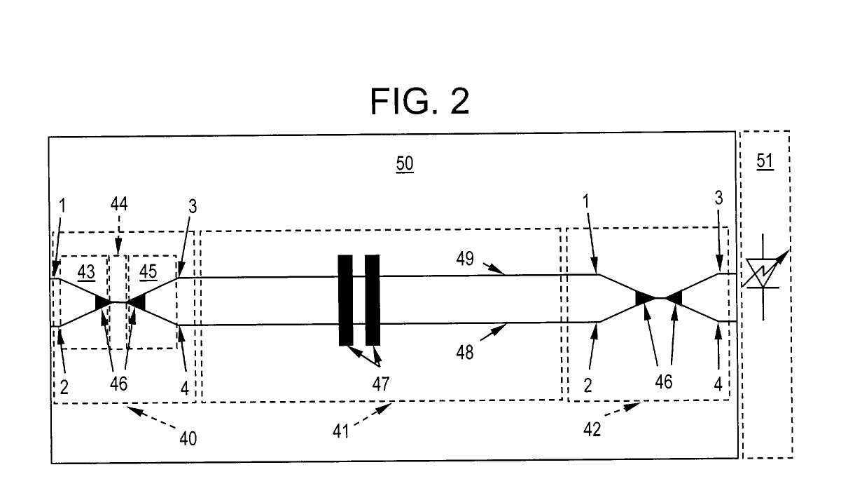

As shown in FIG. 2, an electro-optic material 50 can have waveguide structures that form a splitter section 40, an electrode (mode converter) section 41, and a second splitter section 42. The splitter 40 can have two input waveguides 43 that are separated by approximately 50 um, or any other desired separation. Smaller or larger separations can be used, depending on desired isolation between these input waveguides. The waveguides can converge towards each other with a convergence angle of approximately 0.55 degrees full angle, or any other appropriate angle depending upon the modal birefringence of the waveguides. When the waveguides are approximately 7 um separated, the convergence angle returns to zero. This “zero-gap” section 44 is, thus, approximately 14 um wide. Other gap distances between the waveguides may be used in a non “zero-gap” type device. According to an exemplary embodiment, the “zero-gap” section 44 can be approximately 310 urn long, although other lengths can be used to effect any desired multimode interaction. The output waveguides of the splitter 45 can also diverge at approximately 0.55 degrees full angle, to a separation of approximately 50 um. Due to photolithographic constraints, an additional isosceles triangle of titanium can be inserted at the apex of both the input and output ends of the splitters 46, such that the smallest separation between the waveguides to be resolved photolithographically is approximately 2 um. The size of this triangle can be made arbitrarily small depending on the quality of the photolithography available.

The splitters can be considered as, for example, a four port device with two input ports at one end of the device, and two output ports at the other end of the device. According to an exemplary embodiment, the length of the zero gap section 44 can be selected such that TE polarized light entering port 1 exits via port 4, TM polarized light that enters port 1 exits via port 3, TE polarized light entering port 2 exits via port 3, and TM polarized light entering port 2 exits via port 4, although many desired lengths of the zero gap section can be used to control the entering and exiting of the TE and TM polarized light in many combinations of ports. Consequently, in such an exemplary embodiment, if input port 1 or input port 2 is used, exemplary embodiments of the present invention can function as a polarization splitter. If one output port is used, exemplary embodiments can combine one polarization from one input port with the other polarization of the other input port. Similarly, if only one input port is used and one output port is used, exemplary embodiments can act as a polarizer.

In the exemplary embodiment of FIG. 2, the input light can enter the first splitter 40 via a single port 1. Thus, the device can split the TE and TM components of the light into separate waveguides. For purposes of illustration and not limitation, waveguide 48 can be the guide with predominantly TE light, and waveguide 49 can be the guide with predominantly TM light, although either waveguide can be used for either type of polarized light. According to this illustration, the mode converter sections 41 of these waveguides can wavelength selectively couple the TE energy at the preferred wavelengths in waveguide 48 into the TM mode of waveguide 49. This wavelength selectivity is enabled by the difference in the propagation constants of the TE and TM modes. Similarly, the TM energy at the preferred wavelengths in waveguide 49 can be coupled into the TE mode of waveguide 48. This process is described in detail in U.S. patent application Ser. No. 09/954,495, filed Sep. 10, 2001, entitled “Wavelength Agile Laser.” According to exemplary embodiments, the electrodes 47 that cause this wavelength-selective coupling can be placed in close proximity to either or both waveguide 48 and waveguide 49.

In the mode converter section 41, the voltage on each electrode, group of electrodes, or subgroups of electrodes is independently controlled by the voltage source 25 and a processor or other circuitry, allowing the synthesis of electric fields in the electro-optic waveguides 48 and 49. Since, for example, LiNbO₃ is an electro-optic material, the electric fields can alter the index of refraction in the waveguides 48 and 49 in direct proportion to the strength of the electric field in the material.

Spatial variations in the index of refraction of a waveguide (such as variations caused by the electric field in the electro-optic material) can induce wavelength-selective coupling of energy from one waveguide mode to another waveguide mode, where the modes have different propagation constants. The coupling of energy is governed by the following equations (1), (2), and (3):

$$\begin{matrix}\frac{ⅆ ( TM )}{ⅆ z} = - ⅈ κ ( z ) ( TE ) {ⅇ}^{- ⅈ ( {β}_{TM} - {β}_{TE} ) z} & ( 1 ) \\ \frac{ⅆ ( TE )}{ⅆ z} = - ⅈ κ ( z ) ( TM ) {ⅇ}^{ⅈ ( {β}_{TM} - {β}_{TE} ) z} & ( 2 ) \\ κ ( z ) = \frac{{β}_{TM}}{4} {\int }_{- ∞}^{∞} \frac{{ϵ}^{2} r ( x , z ) {E}^{( 0 )} ( x , z )}{ϵ ( x ) {ϵ}_{0}} {H}^{TE} ( x ) {E}^{TM} ( x ) ⅆ x & ( 3 )\end{matrix}$$

where: TM is the complex amplitude of the TM mode, TE is the complex amplitude of the TE mode; r(x,z) is the electro-optic tensor of the material; ∈(x) is the permitivity of the material; ∈₀ is the permitivity of free space; H^{TE}(x) is the magnetic field associated with the TE mode; and E^{TM}(x) is the electric field associated with the TM mode. For a complete discussion of wavelength-sensitive mode coupling, see “Quantum Electronics (Third Edition),” by Amnon Yariv, John Wiley & Sons, Inc., 1989.

The light exiting the mode converter sections of waveguide 48 and waveguide 49 can then be fed into the input ports of the splitter device 42. The desired light (e.g., TM light from waveguide 48 and the TE light from waveguide 49) can be combined and coupled into the output port 4 of splitter 42, while the “waste light”, that is, the TE light from waveguide 48 and TM light from waveguide 49, can be similarly combined and coupled into the output port 3 of the splitter device 42. The desired light then exits the electro-optic material 50, and is directed at, for example, the photodetector 51.

In the absence of the photodetector 51, exemplary embodiments can be considered a tunable passband filter. As described by the mode coupling equations (1), (2) and (3), different choices of applied voltages can effect different filter transfer functions. For example, if the output port is considered to be port 3 of the splitter device 42, and again the photodetector 51 is absent, exemplary embodiments of the present invention can be considered a tunable bandstop filter. As described by the mode coupling equations (1), (2) and (3), different choices of applied voltages can effect different filter transfer functions.

In another exemplary embodiment, the light travels the length of the device at least two times, each time passing under the mode conversion electrodes, thereby producing a multistage filter. A structure based on a polarization splitter can be used to reverse the direction of propagation of the light, and to simultaneously couple the light into another waveguide. The output of this filter can be fed into a photodetector, if desired.

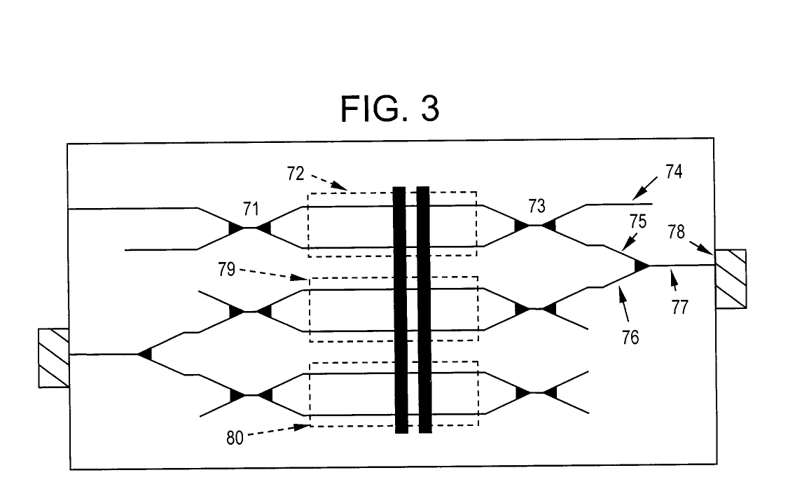

Referring to FIG. 3, the light enters the embodiment and transits a polarization splitter/device 71, the electrode (first filter) section 72, and then through a second splitter 73. The light can then enter one arm of the “zero-gap reflector” 74. The zero-gap reflector can have an arm 75, an arm 76, a zero-gap coupler section 77, and a facet 78 that has been polished and coated with a highly reflective coating. The device geometries and construction techniques of arm 75, arm 76, and the zero-gap coupler can be identical to the construction of the polarization splitter devices, for example, an additional isosceles triangle of titanium can be inserted at the apex between arm 75 and arm 76 such that the smallest separation between the waveguides to be resolved photolithographically is approximately 2 um.

The length of the zero gap coupler section 77 can be chosen such that light in the TE mode and the light in the TM mode that enters the device through arm 75 enters the zero-gap coupler section 77, transit to highly reflective facet 78, reverse direction of propagation, transit the zero-gap coupler section 77 in the opposite direction, and then exit through the arm 76. This type of operation can be achieved if the length of the zero-gap coupler section 77 is, for example, approximately 465 um.

Light exiting the zero-gap coupler can then travel through additional filter sections 79, 80, . . . , that use the same electrodes as the first filter section 72. The use of one or more zero-gap coupler reflectors allows the integrated construction of multistage filters with, for example, 2 to 100 sections of filtering, although any number of filtering sections can be used. The number of sections of filtering may be limited by practical design considerations, for example, the maximum insertion loss that the designer is willing to tolerate.

In another alternative exemplary embodiment, the light travels the length of the device an even number of times, each time passing under mode conversion electrodes, thereby producing a multistage filter. An adaptation of the polarization splitter can be used to reverse the direction of propagation of the light, to simultaneously couple the light into another waveguide, and to convert all the light that was in the TE mode into reverse propagating light in the TM mode and similarly convert all the light that was propagating in the TM mode into reverse propagating TE mode. Since the number of transits of the length of the device can be an even number, and the TE and TM polarizations can be “swapped” at each change in direction of propagation, the polarization dependent loss and polarization mode dispersion (polarization dependent time delay through the device) can be greatly reduced when compared to a device in which an odd number of passes are made through the device, and can be greatly reduced when compared to the exemplary embodiment described in FIG. 3. The effects on the light in each polarization during the odd numbered passes can be applied to the companion light during the even numbered passes, thereby mitigating unwanted asymmetric processing of each of the polarizations.

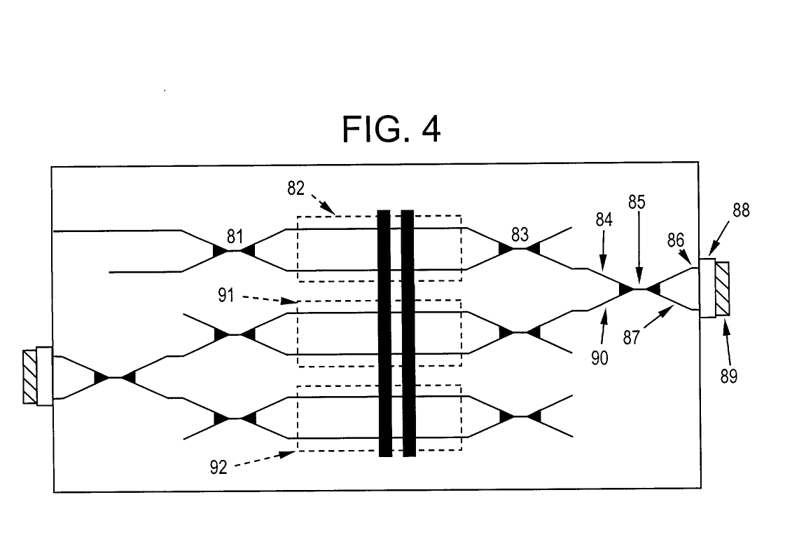

Referring to FIG. 4, the light can enter the present invention and can transit a polarization splitter/device 81, the electrode (first filter) section 82, and then through a second splitter 83. Light from the desired output arm can be coupled into arm 84 of polarization splitter 85. Consequently, the desired TE light can exit splitter 85 via arm 87, and the desired TM light can exit splitter 85 via arm 86. Light from arm 86 and arm 87 can exit the LiNbO₃ device, transit a quarter-waveplate 88 made of quartz, polyamide or the like, reflect off a highly reflective surface 89, and transit the quarter-waveplate 88 in the opposite direction. The principle axes of the quarter-waveplate 88 can be oriented approximately 45 degrees to the principle axes of the LiNbO₃ substrate. Consequently, light that was in the forward propagating TE mode in arm 87 can be reflected to the reverse propagating TM mode in arm 87. Similarly, light that was in the forward propagating TM mode in arm 86 can be reflected to the reverse propagating TE mode in arm 86.

Using the polarization splitter/combiner 85, the reverse propagating TE polarized light in arm 86 can be coupled to reverse propagating TE polarized light in arm 90, and, similarly, the reverse propagating TM polarized light in arm 87 can be coupled to reverse propagating TM polarized light in arm 90.

Light exiting arm 90 can then travel through additional filter sections 91, 92, . . . , that can use the same electrodes as the first filter section 82, or can use independently controlled electrodes, groups of electrodes, or subgroups of electrodes in the groups of electrodes. The use of one, three, five or more polarization reversing reflectors in combination with a splitter in order to redirect the light into another filter section allows the integrated construction of multistage filters with, for example, 2, 4, . . . 100 sections of filtering, although any number of polarization reversing reflectors and any number of filtering sections can be used. The number of sections of filtering may be limited by practical design considerations, for example, the maximum insertion loss that the designer is willing to tolerate.

Referring to FIG. 2, an exemplary embodiment for introducing the polarizing effect at the end of each polarization conversion section (other than a polarization splitter) can include the construction a TM pass polarizer on the output of waveguide 48 and a TE pass polarizer on the output of waveguide 49. A TE pass polarizer can be constructed by depositing a polarization electrode on top of the waveguide 49 without an intermediate buffer layer 23 (of FIG. 1), or with a thinner buffer layer 23, for example, approximately 200 A of SiO₂. The polarization electrode can be made of sputtered aluminum, chromium or any other metal with similar permitivity properties at optical wavelengths. A TM pass polarizer can be effected by a structure that preferentially passes TM polarized light, for example, the structure described in “Integrated Optical Proton Exchange TM-Pass Polarizers in LiNbO₃: Modelling and Experimental Performance,” IEEE Journal of Lightwave Technology, Vol. 13, No. 8, August 1995.

In a multistage filter, one polarizer can be used on each arm at the end of each section of the filter.

In summary, the application of spatially-varying electric fields can induce wavelength-dependent mode conversion. If the electric fields are chosen properly, one wavelength of light can be more efficiently coupled from the TE mode to the TM mode in, for example, waveguide 48, and from the TM mode to the TE mode in, for example, waveguide 49. Thus, the polarization in the splitters and the wavelength selective polarization mode conversion in the LiNbO₃ waveguide near the electrodes act in concert to allow only the preferred wavelengths to exit the output port.

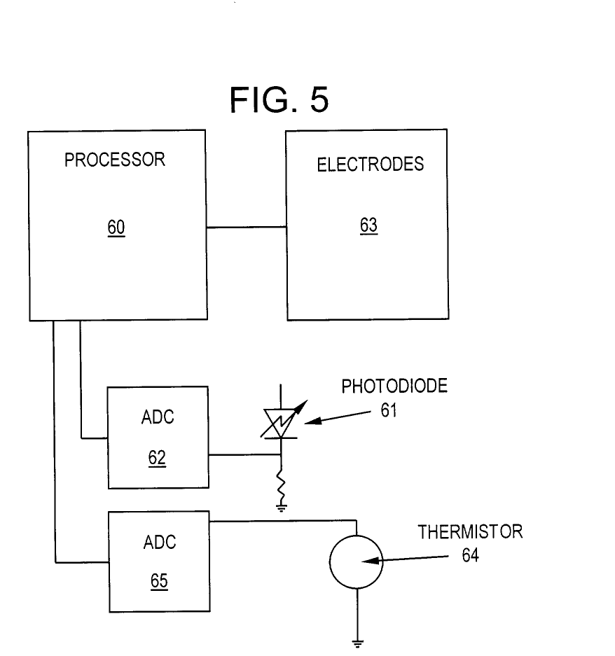

Referring to FIG. 5, a computer-controlled embodiment in accordance with the present invention is shown. The processor 60 can comprise any type of processor (e.g., a microprocessor, a microcontroller, or the like), any type of computer system (e.g., a general purpose computer, a personal computer (PC), workstation, or the like), a digital signal processing (DSP) processor or system, an application-specific integrated circuit (ASIC), a programmable read-only memory (PROM), an erasable programmable read-only memory (EPROM), an electrically-erasable programmable read-only memory (EEPROM), or the like. The processor 60 can independently energize each electrode, group of electrodes, or subgroups of electrodes within the groups of electrodes to produce a spatially-varying electric field that produces the desired transfer function.

An exemplary method by which the processor can drive the electrodes of FIG. 1 to measure the power in the light will now be described. Referring to FIG. 5, a processor 60 can be coupled to the photodiode 61 via an ADC 62. The processor 60 can also be coupled to the drive electronics that control the voltages on the electrodes 63.

In an exemplary OPM embodiment, the processor 60 can output the voltages to the M electrodes, groups of electrodes, or subgroups of electrodes according to the following equation (4):

V₁=CW₁cos(2π(Δn)Di/λ) (4)

where V₁ is the voltage on the i^{th} electrode, 0<i<M, C is a constant amplitude that can be chosen to maximize the power that is mode-converted in both waveguide 48 and waveguide 49, W₁ represents a standard windowing function, such as, for example, the Bartlett windowing function given by the following equation (5), although any standard windowing function can be used:

$${W}_{i} = \{ \begin{matrix}2 i / M & 0 \leq i \leq M / 2 \\ 2 - 2 i / M & M / 2 < i \leq M\end{matrix} \qquad ( 5 )$$

Δn is the effective birefringence of the waveguide, D is the center-to-center distance between the electrodes, groups of electrodes, or subgroups of electrodes within the groups of electrodes along the waveguide in the direction of light propagation, and λ is the wavelength of light at which the power is to be measured. The processor 60 can then integrate the current that is flowing through the photodiode for a period of time, thereby obtaining a measure of the power that is in the light at a wavelength centered at λ. The processor 60 can then change the voltages on the electrodes, groups of electrodes, or subgroups of electrodes within the groups of electrodes in order to measure the power at a different wavelength λ.

Processor 60 can be coupled to receive a temperature signal from a thermistor 64 via an analog-to-digital converter (ADC) 65. Thermistor 64 can be physically attached to waveguide chip (electro-optic material) 50 (of FIG. 2) to provide a measure of the temperature of the waveguide chip (electro-optic material) 50. During device manufacture, the device can be calibrated with respect to temperature by measuring the effective birefringence (e.g., by comparing the center wavelength of the filter to a known reference) as a function of device temperature. This calibration table can be stored in a non-volatile fashion in a computer memory associated with the processor 60. The computer memory can be any type of computer memory or any other type of electronic storage medium that is located either internally or externally to the processor 60, such as, for example, read-only memory (ROM), random access memory (RAM), compact disc read-only memory (CDROM), electro-optical memory, magneto-optical memory, or the like. If located externally to the processor 60, the computer memory can be connected to processor 60 using any type of electrical connection capable of communicating electrical information between the computer memory and the processor 60. The calibration table can be used to determine the appropriate An when computing the electrode voltages.

Exemplary embodiments of the present invention can be used in, for example, a telecommunications network to allow the measurement of light at precisely-controlled wavelengths (frequencies). This capability allows the remote monitoring of network performance, and diagnosis of network problems. In an advanced system, information from an optical performance monitor can be used, for example, as the sensor in a feedback loop in order to automatically control the network.

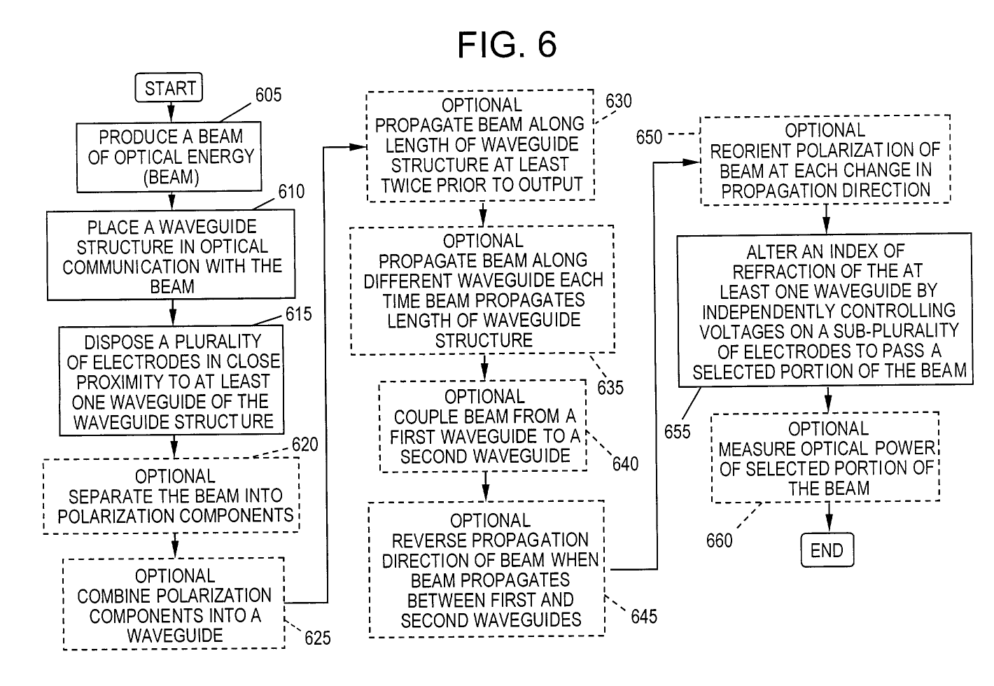

FIG. 6 is a flowchart illustrating steps for measuring optical power, in accordance with an exemplary embodiment of the present invention. In step 605, a beam of optical energy is produced. The beam of optical energy can be produced by, for example, a laser diode. In step 610 a waveguide structure is placed in optical communication with a beam of optical energy. The waveguide structure includes at least one waveguide. Each of the at least one waveguide comprises an electro-optical material. Each of the at least one waveguide includes an input end and an output end, in which the input end is configured to receive the beam of optical energy, and the output end is configured to pass the beam of optical energy. In step 615, a plurality of electrodes is disposed in close proximity to at least one waveguide of the waveguide structure and along a longitudinal axis of the at least one waveguide.

After several optional steps, each of which is discussed below, in step 655 an index of refraction of the at least one waveguide is altered at positions adjacent to each of a sub-plurality of electrodes of the plurality of electrodes by independently controlling voltages on a sub-plurality of electrodes to pass a selected portion of the beam of optical energy. According to exemplary embodiments, the electro-optical material comprises a refractive index that changes with changes in voltage applied to the sub-plurality of electrodes. For example, the electro-optical material can comprise lithium niobate (LiNbO₃), or any other material that can exhibit similar characteristics. In step 660, the optical power of the selected portion of the beam of optical energy can be optionally measured. The optical power can be measured by, for example, a photodetector or any other type of device that is capable of measuring the optical power of the beam of optical energy. Alternatively, the selected portion of the beam of optical energy can be passed to any device or to any location without measurement (e.g., a device or receiver located remotely over a fiber optic telecommunications network).

According to an exemplary embodiment, each sub-plurality of electrodes comprises an individual electrode. According to an alternative exemplary embodiment, each sub-plurality of electrodes comprises a group of electrodes. According to another alternative exemplary embodiment, each sub-plurality of electrodes comprises a subgroup of electrodes, wherein a group of electrodes includes at least two subgroups of electrodes. For example, a group of electrodes can include two subgroups of electrodes, and a subgroup of electrodes can include five electrodes, although any number of groups can be used, with each group comprising any number of electrodes. According to an exemplary embodiment, the voltages on the sub-plurality of electrodes are independently controlled to control a center wavelength of the beam of optical energy.

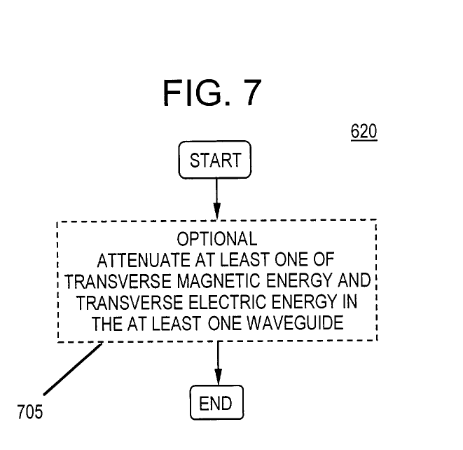

Optionally, in step 620, the beam of optical energy can be separated into polarization components, in which each polarization component propagates along a waveguide of the waveguide structure. FIG. 7 is a flowchart illustrating steps for separating a beam of optical energy into polarization components, in accordance with an exemplary embodiment of the present invention. In step 705 of FIG. 7, the transverse magnetic energy and/or the transverse electric energy can be attenuated in the at least one waveguide.

Referring to FIG. 6, in step 625, polarization components from each waveguide of the waveguide structure can be optionally combined into one waveguide. In step 630, the beam of optical energy can be optionally propagated along a length of the waveguide structure at least twice prior to being passed from the output end of the at least one waveguide. According to an exemplary embodiment, the beam of optical energy propagates along the length of the waveguide structure an even number of times. In step 635, the beam of optical energy can be optionally propagated along a different waveguide of the waveguide structure each time the beam of optical energy propagates the length of the waveguide structure.

In step 640, the beam of optical energy can be optionally coupled from a first waveguide to a second waveguide as the beam of optical energy propagates along the length of the waveguide structure. If coupling occurs, then in step 645, the direction of propagation of the beam of optical energy can be reversed when the beam of optical energy propagates between the first waveguide and the second waveguide. Consequently, in step 650, the polarization of the beam of optical energy can be reoriented at each change in propagation direction.

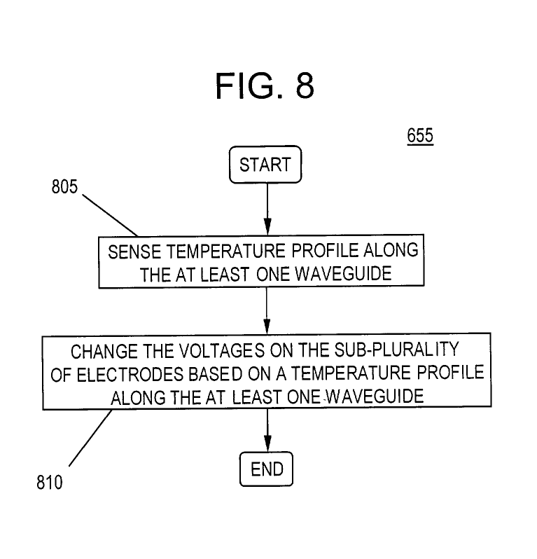

FIG. 8 is a flowchart illustrating steps for altering an index of refraction of at least one waveguide, in accordance with an exemplary embodiment of the present invention. In step 805, a temperature profile along the at least one waveguide can be sensed, for example, by a temperature sensor. In step 810, the voltages on the sub-plurality of electrodes can be changed based on the temperature profile along the at least one waveguide.

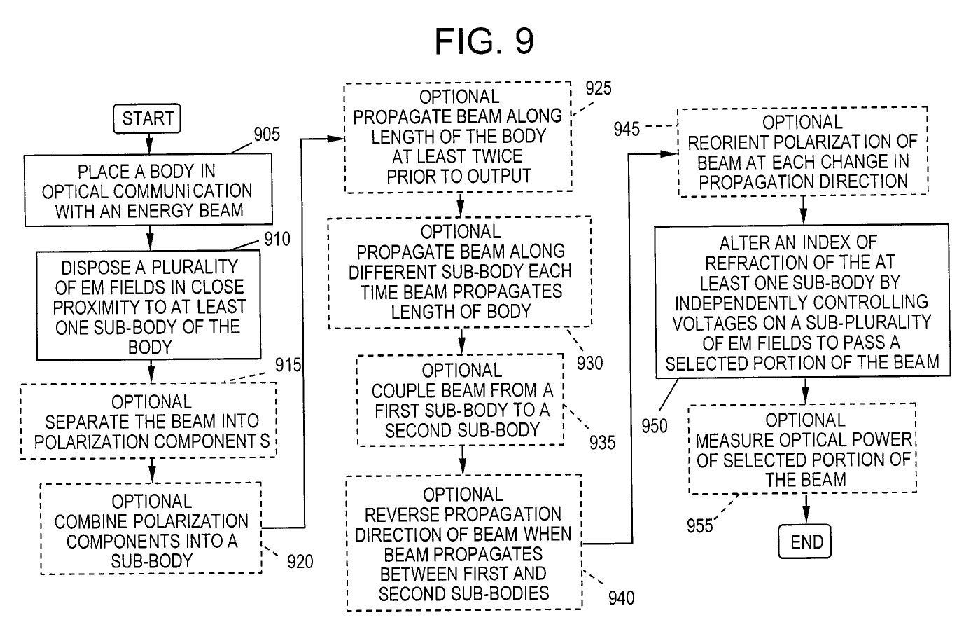

FIG. 9 is a flowchart illustrating steps for measuring optical power, in accordance with an alternative exemplary embodiment of the present invention. In step 905, a body is placed in optical communication with an energy beam. According to exemplary embodiments, the body can be, for example, a waveguide structure. The body includes at least one sub-body. According to exemplary embodiments, each sub-body can be, for example, a waveguide of the waveguide structure. Each sub-body comprises an electro-optical material. Each sub-body includes an input end for receiving the energy beam, an output end for emitting an output energy beam, and a longitudinal axis. In step 910, a plurality of electromagnetic fields are disposed in close proximity to the at least one sub-body and along a longitudinal axis of the at least one sub-body.

After several optional steps, each of which is discussed below, in step 950, an index of refraction of the at least one sub-body is altered along the longitudinal axis by independently controlling a sub-plurality of the plurality of electromagnetic fields to emit a selected portion of the energy beam. According to exemplary embodiments, the electro-optical material comprises a refractive index that changes with changes in the applied electromagnetic fields. For example, the electro-optical material can comprise lithium niobate (LiNbO₃), or any other material that can exhibit similar characteristics. In step 955, the optical power of the selected portion of the energy beam can be optionally measured. The optical power can be measured by, for example, a photodetector or any other type of device that is capable of measuring the optical power of the beam of optical energy. Alternatively, the selected portion of the energy beam can be passed to any device or to any location without measurement (e.g., a device or receiver located remotely over a fiber optic telecommunications network).

According to an exemplary embodiment, each sub-plurality of electromagnetic fields comprises an individual electromagnetic field. According to an alternative exemplary embodiment, each sub-plurality of electromagnetic fields comprises a group of electromagnetic fields. According to another alternative exemplary embodiment, each sub-plurality of electromagnetic fields comprises a subgroup of electromagnetic fields, wherein a group of electromagnetic fields includes at least two subgroups of electromagnetic fields. For example, a group of electromagnetic fields can include two subgroups of electromagnetic fields, and a subgroup of electromagnetic fields can include five electromagnetic fields, although any number of groups can be used, with each group comprising any number of electromagnetic fields.

Optionally, in step 915, the energy beam can be separated into polarization components, wherein each polarization component propagates along one of the at least one sub-body. In step 920, the polarization components can be optionally combined from each sub-body into a sub-body. In step 925, the energy beam can be optionally propagated along a length of the body at least twice prior to being passed from the output end of the at least one sub-body. According to an exemplary embodiment, the energy beam can be propagated along the length of the body an even number of times. In step 930, the energy beam can be optionally propagated along a different sub-body each time the energy beam propagates the length of the body.

In step 935, the energy beam from a first sub-body can be optionally coupled to a second sub-body as the energy beam propagates along the length of the body. If coupling occurs, then in step 940, a direction of propagation of the energy beam can be reversed when the energy beam propagates between the first sub-body and the second sub-body. Consequently, the polarization of the energy beam can be reoriented at each change in propagation direction.

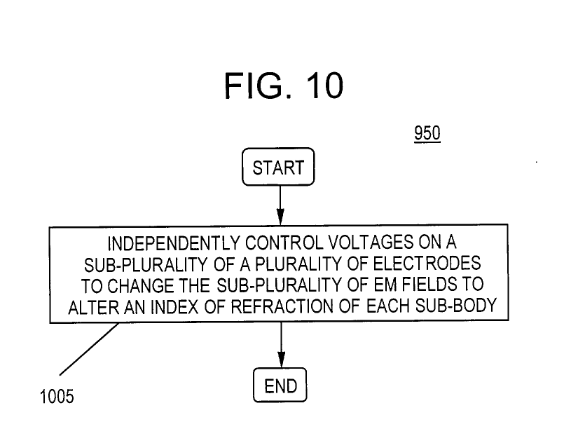

FIG. 10 is a flowchart illustrating steps for altering an index of refraction of at least one sub-body, in accordance with an exemplary embodiment of the present invention. In step 1005, the voltages on a sub-plurality of a plurality of electrodes are independently controlled to change the sub-plurality of electromagnetic fields to alter an index of refraction of each sub-body. According to exemplary embodiments, the plurality of electrodes are disposed in close proximity to the at least one sub-body and disposed along a longitudinal axis of the at least one sub-body. According to an exemplary embodiment, the voltages on the sub-plurality of electrodes are independently controlled to change the sub-plurality of electromagnetic fields to control a center wavelength of the energy beam.

According to an exemplary embodiment, each sub-plurality of electrodes comprises an individual electrode. According to an alternative exemplary embodiment, each sub-plurality of electrodes comprises a group of electrodes. According to another alternative exemplary embodiment, each sub-plurality of electrodes comprises a subgroup of electrodes, wherein a group of electrodes includes at least two subgroups of electrodes. For example, a group of electrodes can include two subgroups of electrodes, and a subgroup of electrodes can include five electrodes, although any number of groups can be used, with each group comprising any number of electrodes.

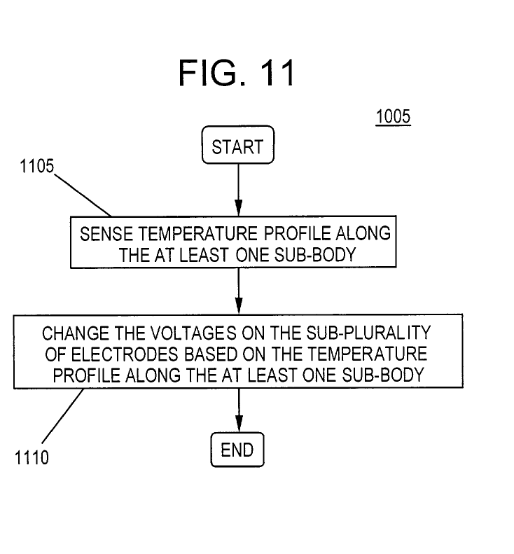

FIG. 11 is a flowchart illustrating steps for independently controlling voltages on a sub-plurality of a plurality of electrodes, in accordance with an exemplary embodiment of the present invention. In step 1105, a temperature profile along the at least one sub-body can be sensed, for example, by a temperature sensor. In step 1110, the voltages on the sub-plurality of electrodes can be changed based on the temperature profile along the at least one sub-body.

The steps of a computer program as illustrated in FIGS. 6-11 for measuring optical power can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All united states patents and applications, foreign patents, and publications discussed above are hereby incorporated herein by reference in their entireties.

What is claimed is:

1. An apparatus for measuring optical power, comprising:
a waveguide structure, wherein the waveguide structure includes at least one waveguide, each of the at least one waveguide being comprised of an electro-optical material, wherein each of the at least one waveguide includes an input end and an output end, wherein the input end is configured to receive a beam of optical energy, wherein the output end is configured to pass the beam of optical energy;
a plurality of electrodes disposed in close proximity to at least one waveguide of the waveguide structure and disposed along a longitudinal axis of the at least one waveguide;
circuitry that independently controls voltages on a sub-plurality of electrodes of the plurality of electrodes to alter an index of refraction of the at least one waveguide at positions adjacent to each sub-plurality of electrodes to pass a selected portion of the beam of optical energy; and,
means for measuring the optical power of the selected portion of the beam of optical energy.

2. The apparatus of claim 1, comprising:
means for producing the beam of optical energy.

3. The apparatus of claim 1, wherein each sub-plurality of electrodes comprises an individual electrode.

4. The apparatus of claim 1, wherein each sub-plurality of electrodes comprises a group of electrodes.

5. The apparatus of claim 1, wherein each sub-plurality of electrodes comprises a subgroup of electrodes, wherein a group of electrodes includes at least two subgroups of electrodes.

6. The apparatus of claim 5, wherein a group of electrodes includes two subgroups of electrodes, and wherein a subgroup of electrodes includes five electrodes.

7. The apparatus of claim 1, comprising:
a first polarization splitter configured to separate the beam of optical energy into polarization components, wherein each polarization component propagates along a waveguide of the waveguide structure.

8. The apparatus of claim 7, comprising:
a second polarization splitter configured to combine polarization components from each waveguide of the waveguide structure into a waveguide.

9. The apparatus of claim 1, wherein the waveguide structure is configured to propagate the beam of optical energy along a length of the waveguide structure at least twice prior to being passed from the output end of the at least one waveguide.

10. The apparatus of claim 9, wherein the beam of optical energy propagates along the length of the waveguide structure an even number of times.

11. The apparatus of claim 9, wherein the beam of optical energy propagates along a different waveguide of the waveguide structure each time the beam of optical energy propagates the length of the waveguide structure.

12. The apparatus of claim 11, comprising:
means for coupling the beam of optical energy from a first waveguide to a second waveguide as the beam of optical energy propagates along the length of the waveguide structure, and for reversing a direction of propagation of the beam of optical energy when the beam of optical energy propagates between the first waveguide and the second waveguide.

13. The apparatus of claim 12, wherein the means for coupling and for reversing the direction of propagation also reorients the polarization of the beam of optical energy at each change in propagation direction.

14. The apparatus of claim 1, wherein the circuitry independently controls the voltages on the sub-plurality of electrodes to control a center wavelength of the beam of optical energy.

15. The apparatus of claim 2, wherein the means for producing the beam of optical energy is butt-coupled to the waveguide structure.

16. The apparatus of claim 2, wherein the means for producing the beam of optical energy is coupled to the waveguide structure by coupling optics.

17 The apparatus of claim 16, wherein the coupling optics comprise a silica lens.

18. The apparatus of claim 1, wherein the circuitry selectively energizes the sub-plurality of electrodes based on a temperature profile along the at least one waveguide.

19. The apparatus of claim 18, comprising:
a temperature sensor coupled to the circuitry and configured to sense the temperature profile along the at least one waveguide.

20. The apparatus of claim 1, wherein the electro-optical material comprises a refractive index that changes with changes in voltage applied to the sub-plurality of electrodes.

21. The apparatus of claim 1, wherein the electro-optical material comprises lithium niobate (LiNbO₃).

22. The apparatus of claim 1, wherein the at least one waveguide comprises an electro-optical material that is x-cut, y-propagating lithium niobate (LiNbO₃).

23. The apparatus of claim 1, wherein the at least one waveguide comprises an electro-optical material that is y-cut, x-propagating lithium niobate (LiNbO₃).

24. The apparatus of claim 1, wherein the at least one waveguide comprises an electro-optical material that is z-cut, x-propagating lithium niobate (LiNbO₃).

25. The apparatus of claim 1, wherein the at least one waveguide comprises an electro-optical material that is z-cut, y-propagating lithium niobate (LiNbO₃).

26. The apparatus of claim 1, wherein the polarization splitter is configured to attenuate at least one of transverse magnetic energy and transverse electric energy in the at least one waveguide.

27. The apparatus of claim 1, wherein an anti-reflective coating is disposed on surfaces of the at least one waveguide.

28. An apparatus for measuring optical power, comprising:
a body comprised of at least one sub-body, wherein each of the at least one sub-body comprises an electro-optical material, each sub-body including an input end for receiving an energy beam from an energy beam source, an output end for emitting an output energy beam, and a longitudinal axis;
a plurality of electromagnetic fields in close proximity to the at least one sub-body and disposed along a longitudinal axis of the at least one sub-body; circuitry that alters an index of refraction of the at least one sub-body along the longitudinal axis by independently controlling a sub-plurality of the plurality of electromagnetic fields to emit a selected portion of the energy beam; and,
means for measuring the optical power of the selected portion of the energy beam.

29. The apparatus of claim 28, wherein the energy beam source comprises a laser diode.

30. The apparatus of claim 28, wherein each sub-plurality of electromagnetic fields comprises an individual electromagnetic field.

31. The apparatus of claim 28, wherein each sub-plurality of electromagnetic fields comprises a group of electromagnetic fields.

32. The apparatus of claim 28, wherein each sub-plurality of electromagnetic fields comprises a subgroup of electromagnetic fields, wherein a group of electromagnetic fields includes at least two subgroups of electromagnetic fields.

33. The apparatus of claim 32, wherein a group of electromagnetic fields includes two subgroups of electromagnetic fields, and wherein a subgroup of electromagnetic fields includes five electromagnetic fields.

34. The apparatus of claim 28, comprising:
means for separating the energy beam into polarization components, wherein each polarization component propagates along one of the at least sub-body.

35. The apparatus of claim 34, comprising:
means for combining polarization components from each sub-body into a sub-body.

36. The apparatus of claim 28, wherein each sub-body is configured to propagate the energy beam along a length of the body at least twice prior to being passed from the output end of the at least one sub-body.

37. The apparatus of claim 36, wherein the energy beam propagates along the length of the body an even number of times.

38. The apparatus of claim 36, wherein the energy beam propagates along a different sub-body each time the energy beam propagates the length of the body.

39. The apparatus of claim 34, comprising:
means for coupling the energy beam from a first sub-body to a second sub-body as the energy beam propagates along the length of the body, and for reversing a direction of propagation of the energy beam when the energy beam propagates between the first sub-body and the second sub-body.

40. The apparatus of claim 39, wherein the means for coupling and for reversing the direction of propagation also reorients a polarization of the energy beam at each change in propagation direction.

41. The apparatus of claim 28, wherein the circuitry independently controls voltages on a sub-plurality of a plurality of electrodes to change the sub-plurality of electromagnetic fields to alter an index of refraction of each sub-body, wherein the plurality of electrodes are disposed in close proximity to the at least one sub-body and disposed along a longitudinal axis of the at least one sub-body

42. The apparatus of claim 41, wherein the circuitry independently controls voltages on the sub-plurality of electrodes to change the sub-plurality of electromagnetic fields to control a center wavelength of the energy beam.

43. The apparatus of claim 41, wherein each sub-plurality of electrodes comprises an individual electrode.

44. The apparatus of claim 41, wherein each sub-plurality of electrodes comprises a group of electrodes.

45. The apparatus of claim 41, wherein each sub-plurality of electrodes comprises a subgroup of electrodes, wherein a group of electrodes includes at least two subgroups of electrodes.

46. The apparatus of claim 45, wherein a group of electrodes includes two subgroups of electrodes, and wherein a subgroup of electrodes includes five electrodes.

47. The apparatus of claim 28, wherein the energy beam source comprises a semiconductor laser medium.

48. The apparatus of claim 47, wherein an anti-reflective coating is disposed on surfaces of the at least one sub-body.

49. The apparatus of claim 28, wherein the energy beam source is butt-coupled to the body.

50. The apparatus of claim 28, wherein the energy beam source is coupled to the body by coupling optics.

51. The apparatus of claim 50, wherein the coupling optics comprise a silica lens.

52. The apparatus of claim 28, wherein the circuitry selectively energizes the sub-plurality of electromagnetic fields based on a temperature profile along the body.

53. The apparatus of claim 52, comprising:
a temperature sensor configured to sense the temperature profile along the at least one sub-body.

54. The apparatus of claim 28, wherein the electro-optical material comprises a refractive index that changes with changes in the applied electromagnetic field.

55. The apparatus of claim 28, wherein the electro-optical material comprises lithium niobate (LiNbO₃).

56. The apparatus of claim 28, wherein the at least one sub-body comprises an electro-optical material that is x-cut, y-propagating lithium niobate (LiNbO₃).

57. The apparatus of claim 28, wherein the at least one sub-body comprises an electro-optical material that is y-cut, x-propagating lithium niobate (LiNbO₃).

58. The apparatus of claim 28, wherein the at least one sub-body comprises an electro-optical material that is z-cut, x-propagating lithium niobate (LiNbO₃).

59. The apparatus of claim 28, wherein the at least one sub-body comprises an electro-optical material that is z-cut, y-propagating lithium niobate (LiNbO₃).

60. A method for measuring optical power, comprising the steps of:
placing a waveguide structure in optical communication with a beam of optical energy, wherein the waveguide structure includes at least one waveguide, wherein each of the at least one waveguide comprises an electro-optical material, wherein each of the at least one waveguide includes an input end and an output end, wherein the input end is configured to receive the beam of optical energy, wherein the output end is configured to pass the beam of optical energy;
disposing a plurality of electrodes in close proximity to at least one waveguide of the waveguide structure and along a longitudinal axis of the at least one waveguide;
altering an index of refraction of the at least one waveguide at positions adjacent to each of a sub-plurality of electrodes of the plurality of electrodes by independently controlling voltages on a sub-plurality of electrodes to pass a selected portion of the beam of optical energy; and,
measuring the optical power of the selected portion of the beam of optical energy.

61. The method of claim 60, comprising the step of:
producing the beam of optical energy.

62. The method of claim 60, wherein each sub-plurality of electrodes comprises an individual electrode.

63. The method of claim 60, wherein each sub-plurality of electrodes comprises a group of electrodes.

64. The method of claim 60, wherein each sub-plurality of electrodes comprises a subgroup of electrodes, wherein a group of electrodes includes at least two subgroups of electrodes.

65. The method of claim 64, wherein a group of electrodes includes two subgroups of electrodes, and wherein a subgroup of electrodes includes five electrodes.

66. The method of claim 60, comprising the step of:
separating the beam of optical energy into polarization components, wherein each polarization component propagates along a waveguide of the waveguide structure.

67. The method of claim 66, wherein the step of separating comprises the step of:
attenuating at least one of transverse magnetic energy and transverse electric energy in the at least one waveguide.

68. The method of claim 66, comprising the step of:
combining polarization components from each waveguide of the waveguide structure into a waveguide.

69. The method of claim 60, comprising the step of:
propagating the beam of optical energy along a length of the waveguide structure at least twice prior to being passed from the output end of the at least one waveguide.

70. The method of claim 69, wherein the beam of optical energy propagates along the length of the waveguide structure an even number of times.

71. The method of claim 69, comprising the step of:
propagating the beam of optical energy along a different waveguide of the waveguide structure each time the beam of optical energy propagates the length of the waveguide structure.

72. The method of claim 71, comprising the steps of:
coupling the beam of optical energy from a first waveguide to a second waveguide as the beam of optical energy propagates along the length of the waveguide structure;
reversing a direction of propagation of the beam of optical energy when the beam of optical energy propagates between the first waveguide and the second waveguide.

73. The method of claim 72, comprising the step of:
reorienting the polarization of the beam of optical energy at each change in propagation direction.

74. The method of claim 60, wherein the voltages on the sub-plurality of electrodes are independently controlled to control a center wavelength of the beam of optical energy.

75. The method of claim 60, wherein the step of altering comprises the step of:
sensing a temperature profile along the at least one waveguide.

76. The method of claim 75, wherein the step of altering comprises the step of:
changing the voltages on the sub-plurality of electrodes based on the temperature profile along the at least one waveguide.

77. The method of claim 60, wherein the electro-optical material comprises a refractive index that changes with changes in voltage applied to the sub-plurality of electrodes.

78. The method of claim 60, wherein the electro-optical material comprises lithium niobate (LiNbO₃).

79. An method for measuring optical power, comprising the steps of:
placing a body in optical communication with an energy beam, wherein the body includes at least one sub-body, wherein each of the at least one sub-body comprises an electro-optical material, each sub-body including an input end for receiving the energy beam, an output end for emitting an output energy beam, and a longitudinal axis;
disposing a plurality of electromagnetic fields in close proximity to the at least one sub-body and along a longitudinal axis of the at least one sub-body; altering an index of refraction of the at least one sub-body along the longitudinal axis by independently controlling a sub-plurality of the plurality of electromagnetic fields to emit a selected portion of the energy beam; and, measuring the optical power of the selected portion of the energy beam.

80. The method of claim 79, wherein each sub-plurality of electromagnetic fields comprises an individual electromagnetic field.

82. The method of claim 79, wherein each sub-plurality of electromagnetic fields comprises a group of electromagnetic fields.

83. The method of claim 79, wherein each sub-plurality of electromagnetic fields comprises a subgroup of electromagnetic fields, wherein a group of electromagnetic fields includes at least two subgroups of electromagnetic fields.

84. The method of claim 83, wherein a group of electromagnetic fields includes two subgroups of electromagnetic fields, and wherein a subgroup of electromagnetic fields includes five electromagnetic fields.

85. The method of claim 79, comprising the step of:
separating the energy beam into polarization components, wherein each polarization component propagates along one of the at least sub-body.

86. The method of claim 85, comprising the step of:
combining polarization components from each sub-body into a sub-body.

87. The method of claim 79, comprising the step of:
propagating the energy beam along a length of the body at least twice prior to being passed from the output end of the at least one sub-body.

88. The method of claim 87, wherein the energy beam propagates along the length of the body an even number of times.

89. The method of claim 87, comprising the step of:
propagating the energy beam along a different sub-body each time the energy beam propagates the length of the body.

90. The method of claim 89, comprising the steps of:
coupling the energy beam from a first sub-body to a second sub-body as the energy beam propagates along the length of the body; and
reversing a direction of propagation of the energy beam when the energy beam propagates between the first sub-body and the second sub-body.

91. The method of claim 90, comprising the step of:
reorienting the polarization of the energy beam at each change in propagation direction.

92. The method of claim 79, wherein the step of altering comprises the step of:
independently controlling voltages on a sub-plurality of a plurality of electrodes to change the sub-plurality of electromagnetic fields to alter an index of refraction of each sub-body, wherein the plurality of electrodes are disposed in close proximity to the at least one sub-body and disposed along a longitudinal axis of the at least one sub-body

93. The method of claim 92, wherein the voltages on the sub-plurality of electrodes are independently controlled to change the sub-plurality of electromagnetic fields to control a center wavelength of the energy beam.

94. The method of claim 92, wherein each sub-plurality of electrodes comprises an individual electrode.

95. The method of claim 92, wherein each sub-plurality of electrodes comprises a group of electrodes.

96. The method of claim 92, wherein each sub-plurality of electrodes comprises a subgroup of electrodes, wherein a group of electrodes includes at least two subgroups of electrodes.

97. The method of claim 96, wherein a group of electrodes includes two subgroups of electrodes, and wherein a subgroup of electrodes includes five electrodes.

98. The method of claim 79, wherein the step of independently controlling voltages comprises the step of:
sensing a temperature profile along the at least one sub-body.

99. The method of claim 98, wherein the step of independently controlling voltages comprises the step of:
changing the voltages on the sub-plurality of electrodes based on the temperature profile along the at least one sub-body.

100. The method of claim 79, wherein the electro-optical material comprises a refractive index that changes with changes in the applied electromagnetic field.

101. The method of claim 28, wherein the electro-optical material comprises lithium niobate (LiNbO₃).

102. An apparatus for measuring optical power, comprising:
a waveguide structure, wherein the waveguide structure includes at least one waveguide, each of the at least one waveguide being comprised of an electro-optical material, wherein each of the at least one waveguide includes an input end and an output end, wherein the input end is configured to receive a beam of optical energy, wherein the output end is configured to pass the beam of optical energy;
a plurality of electrodes disposed in close proximity to at least one waveguide of the waveguide structure and disposed along a longitudinal axis of the at least one waveguide; and
circuitry that independently controls voltages on a sub-plurality of electrodes of the plurality of electrodes to alter an index of refraction of the at least one waveguide at positions adjacent to each sub-plurality of electrodes to pass a selected portion of the beam of optical energy.

103. The apparatus of claim 102, comprising:
means for measuring the optical power of the selected portion of the beam of optical energy.

104. The apparatus of claim 102, comprising:
means for producing the beam of optical energy.

105. The apparatus of claim 102, wherein each sub-plurality of electrodes comprises an individual electrode.

106. The apparatus of claim 102, wherein each sub-plurality of electrodes comprises a group of electrodes.

107. The apparatus of claim 102, wherein each sub-plurality of electrodes comprises a subgroup of electrodes, wherein a group of electrodes includes at least two subgroups of electrodes.

108. The apparatus of claim 107, wherein a group of electrodes includes two subgroups of electrodes, and wherein a subgroup of electrodes includes five electrodes.

109. A method for measuring optical power, comprising the steps of:
placing a waveguide structure in optical communication with a beam of optical energy, wherein the waveguide structure includes at least one waveguide, wherein each of the at least one waveguide comprises an electro-optical material, wherein each of the at least one waveguide includes an input end and an output end, wherein the input end is configured to receive the beam of optical energy, wherein the output end is configured to pass the beam of optical energy;
disposing a plurality of electrodes in close proximity to at least one waveguide of the waveguide structure and along a longitudinal axis of the at least one waveguide; and
altering an index of refraction of the at least one waveguide at positions adjacent to each of a sub-plurality of electrodes of the plurality of electrodes by independently controlling voltages on a sub-plurality of electrodes to pass a selected portion of the beam of optical energy.

110. The method of claim 109, comprising the step of:
measuring the optical power of the selected portion of the beam of optical energy.

111. The method of claim 109, comprising the step of:
producing the beam of optical energy.

112. The method of claim 109, wherein each sub-plurality of electrodes comprises an individual electrode.

113. The method of claim 109, wherein each sub-plurality of electrodes comprises a group of electrodes.

114. The method of claim 109, wherein each sub-plurality of electrodes comprises a subgroup of electrodes, wherein a group of electrodes includes at least two subgroups of electrodes.

115. The method of claim 114, wherein a group of electrodes includes two subgroups of electrodes, and wherein a subgroup of electrodes includes five electrodes.
